(19) United States
(12) Patent Application Publication
(10) Pub. No.: US 2022/0327999 A1
(43) Pub. Date: Oct. 13, 2022

(54) TECHNIQUE FOR PARTIAL AREA DISPLAY

(71) Applicant: Google LLC, Mountain View, CA (US)

(72) Inventors: Sangmoo Choi, Palo Alto, CA (US); Janghoon Song, Seoul (KR); Wonjae Choi, San Jose, CA (US)

(21) Appl. No.: 17/635,774

(22) PCT Filed: Nov. 8, 2019
(86) PCT No.: PCT/US2019/060495

§ 371 Date: Feb. 16, 2022

Related U.S. Application Data
(60) Provisional application No. 62/928,965, filed on Oct. 31, 2019.

(51) Int. Cl. G09G 3/3233

(52) U.S. Cl. CPC G09G 3/3233; G09G 2310/04; G09G 2310/0286; G09G 2310/08; G09G 2330/023

(57) ABSTRACT

Methods, systems, and apparatus, including computer programs encoded on computer storage media, for driving a display with an array of light-emitting pixels. The pixels are arranged in a plurality of rows. The array includes two or more independently drivable areas. Each area includes two or more adjacent rows. The method includes, during an image frame, while operating in a first mode of operation, activating a first shift register circuit addressing only rows of pixels in a first area of the independently drivable areas. Activating the first register circuit illuminates one or more pixels in the first area. The method also includes, during the image frame, while operating in the first mode of operation, deactivating a second shift register circuit addressing only rows of pixels in a second area of the independently drivable areas. Deactivating the second register circuit maintains every pixel in the second area unilluminated during the image frame.

### TECHNICAL FIELD

This specification relates generally to flat panel displays and reducing power consumption of flat panel displays.

### BACKGROUND

Electronic devices may include flat panel displays on which visual images may be shown. A flat panel display can operate in multiple different modes, such as a normal operating mode and a power save mode.

### SUMMARY

Techniques are described for partial area display to reduce power consumption.

A flat panel display system can have multiple modes of operation. In a normal operating mode, most or all pixels of a display may be addressable to be illuminated to contribute light to displayed images. In a power save mode, some or all pixels of the display may be non-addressable, so that they don't provide any illumination for displaying images. An always-on display can maintain some pixels illuminated during the power save mode so that the display can still provide imagery when the display is in this mode. The illuminated pixels can display images without requiring interaction from a user. An always-on display can consume more power than a display that does not illuminate any pixels in the power save mode. Greater power consumption can reduce battery life in an always-on display.

Power consumption of always-on displays can be reduced by addressing only a portion of the pixels, instead of addressing all of the pixels. In order to address only a portion of the pixels, the display can be divided into two or more display areas. Each display area can include one or more pixel rows. Each display area can be addressed by a separate shift register circuit. During the power save mode, driving circuitry can address all pixels in certain display areas, and may not address any pixels in certain other display areas. The display can show images in only the display areas in which the pixels were addressed.

In general, one innovative aspect of the subject matter described in this specification can be embodied in a method of driving a display including an array of light-emitting pixels arranged in a plurality of rows, the array including two or more independently drivable areas, each area including two or more adjacent rows. The method includes, during an image frame, while operating in a first mode of operation, activating a first shift register circuit addressing only rows of pixels in a first area of the independently drivable areas to illuminate one or more pixels in the first area. The method can include, during the image frame, while operating in the first mode of operation, deactivating a second shift register circuit addressing only rows of pixels in a second area of the independently drivable areas to maintain every pixel in the second area unilluminated during the image frame.

The foregoing and other embodiments can each optionally include one or more of the following features, alone or in combination. In some implementations, the method can further include, during a second image frame, while operating in a first mode of operation, activating the second shift register circuit addressing only rows of pixels in the second area of the independently drivable areas to illuminate one or more pixels in the second area. The method can include, during the second image frame, while operating in the first mode of operation, deactivating the first shift register circuit addressing only rows of pixels in the first area of the independently drivable areas to maintain every pixel in the first area unilluminated during the image frame.

In some implementations, the method can further include adjusting an input clock signal to a reduced frequency while operating in the first mode of operation.

In some implementations, the method can further include adjusting an input clock signal to a zero frequency while operating in the first mode of operation.

In some implementations, addressing only rows of pixels in the first area can include sending one or more of a gate write signal, a scan signal, and an emission signal to the rows of pixels in the first area.

In some implementations, the display is an always-on display and the first mode of operation is a power save mode.

In some implementations, the display is an always-on display and the second mode of operation is a mode in which all of the independently drivable areas are activated.

In some implementations, activating the first shift register circuit can include sending a first start pulse to the first shift register circuit.

In some implementations, the first start pulse can be one or more of a gate start pulse, a scan start pulse, and an emission start pulse.

Implementations of the above techniques include methods, apparatus, systems and computer program products. One such computer program product is suitably embodied in a non-transitory machine-readable medium that stores instructions executable by one or more processors. The instructions are configured to cause the one or more processors to perform the above-described actions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example electronic device with multiple independently drivable display areas.

FIG. 2 is a diagram of an example display system of an electronic device.

FIG. 3 is a diagram of an example system for driving pixel rows of a display.

FIG. 4 is an example operating timing diagram for a display in a power save mode.

FIGS. 5A and 5B are example operating timing diagrams for displays in a power save mode with reduced clock signal frequency and with zero clock signal frequency.

FIGS. 6A and 6B illustrate an electronic device with alternating active display areas, and an example operating timing diagram for alternating active display areas.

Like reference numbers and designations in the various drawings indicate like elements.

### DETAILED DESCRIPTION

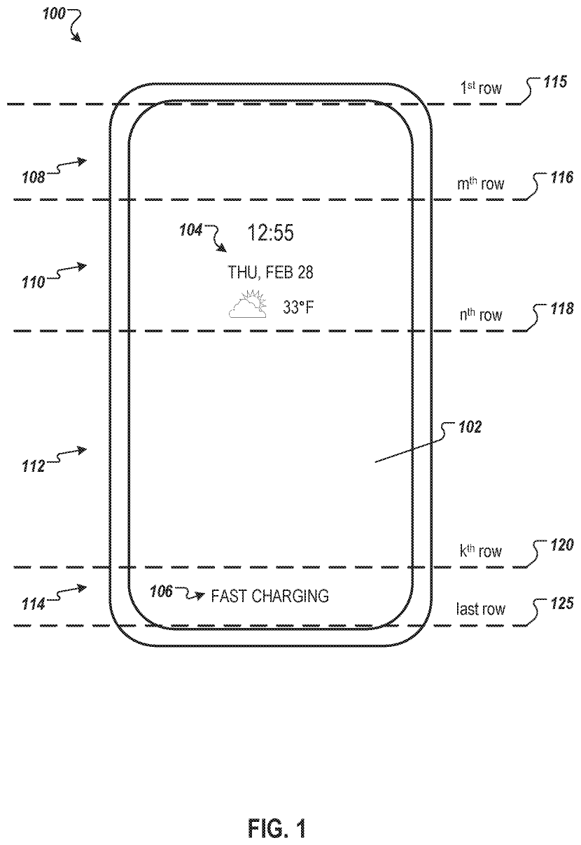

FIG. 1 is a diagram of an example electronic device 100 with multiple independently drivable display areas. FIG. 1 illustrates a front perspective view of the electronic device 100.

The electronic device 100 may be, for example, a smart phone, a television, a smart watch, or a handheld game console. The electronic device 100 includes a display panel 102. The display panel 102 includes an array of light emitting pixels. In operation, the display panel 102 can display an image by illuminating the light emitting pixels. The display panel 102 may be, for example, an active matrix organic light emitting diode (OLED) panel.

The pixels are arranged in a plurality of rows that each extend horizontally across the display panel 102. For example, the display panel 102 can include a 1^{st} row 115, an m^{th} row 116, an n^{th} row 118, a k^{th} row 120, and a last row 125, where m, n, and k each represent an integer value.

The display panel 102 can include multiple independently drivable display areas. For example, the display panel 102 can include three, four, eight, or ten display areas. In the example of FIG. 1, the display panel 102 includes four display areas 108, 110, 112, and 114. Each display area includes two or more adjacent pixel rows. Each display area can include any number of pixel rows that is more than one and less than all of the pixel rows.

The display area 108 includes pixel rows from the 1^{st} row 115 to an (m−1)^{th} row that is adjacent to the m^{th} row 116. The display area 110 includes pixel rows from the m^{th} row 116 to an (n−1)^{th} row that is adjacent to the n^{th} row 118. The display area 112 includes pixel rows from the n^{th} row 118 to a (k−1)^{th} row that is adjacent to the k^{th} row 120. The display area 114 includes pixel rows from the k^{th} row 120 to the last row 125.

The display panel 102 can be an “always-on” display. An always-on display can continuously illuminate at least some of the pixels of the display unless the electronic device 100 is powered off An always-on display can provide users with information without the user interacting with the electronic device 100. However, an always-on display may consume greater amounts of power, and deplete batteries faster, compared to a display that turns off completely when the electronic device 100 is locked or idle.

The always-on display panel 102 can operate in multiple different modes. For example, a first mode can be a power save mode. The display panel 102 can enter the power save mode, for example, when the electronic device 100 remains idle for certain period of time. The display panel can also enter the power save mode when the electronic device 100 is locked.

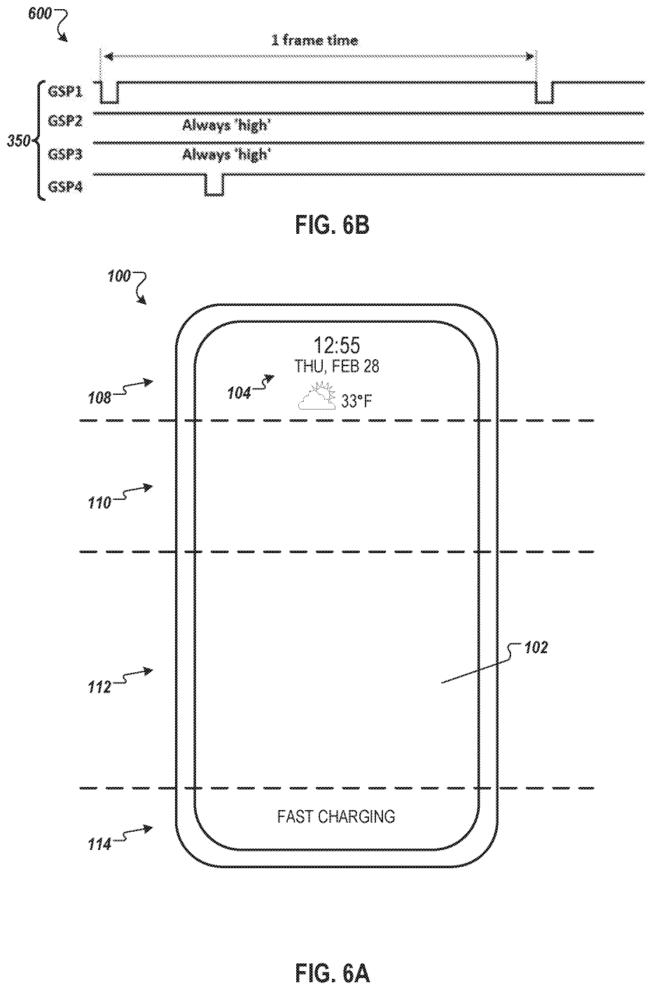

In the power save mode, the display panel 102 can show one or more images by illuminating pixels in one or more, but not all, of the display areas. For example, in the power save mode, the display panel 102 may show a time indication 104 and a charging status 106. The display panel 102 can show the time indication 104 in the display area 110, and the charging status 106 in the display area 114. In some examples, the display panel 102 can alternate active display areas over time. For example, the display panel 102 can alternate to show the time indication 104 in display area 108 instead of display area 110. Alternating active display areas is described in greater detail with reference to FIGS. 6A and 6B.

A second mode can be a normal operating mode. The display panel 102 can enter the normal operating mode, for example, when the electronic device 100 is unlocked and/or in active use. The normal operating mode can include activating all display areas, e.g., illuminating at least some pixels in each of the display areas 108, 110, 112, 114 of the display panel 102.

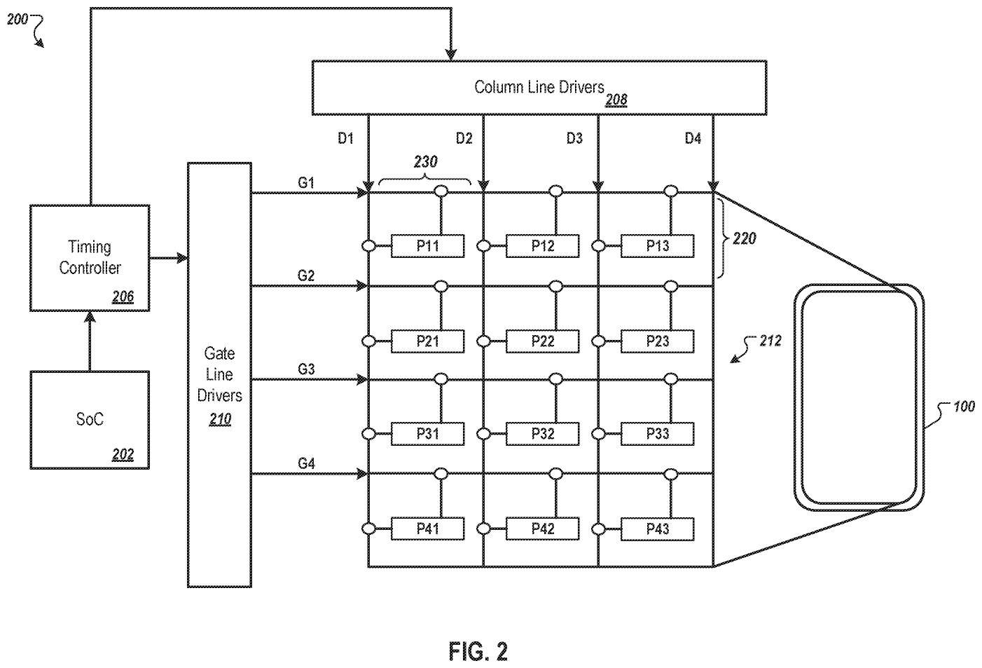

FIG. 2 is a diagram of an example display system 200 of an electronic device. For example, FIG. 2 may illustrate the display system 200 of the electronic device 100. The display system 200 is an OLED display system that includes an array 212 of light emitting pixels. Each light emitting pixel includes an OLED. The OLED display is driven by drivers including gate line drivers 210 and column line drivers 208.

In general, the gate line drivers 210 select a row of pixels in the display, and the column line drivers 208 provide a data voltage to the pixels in the selected row. The pixel circuits generate electric current that corresponds to the data voltage, and provide the current to OLEDs of the pixel, enabling the selected OLEDs to emit light, and presenting an image on the display. Signal lines such as gate lines and column data lines may be used in controlling the pixels to display images on the display. Though FIG. 2 illustrates the display system 200 having the gate line drivers 210 on one side, the gate line drivers 210 can be placed on both left and right sides of the display to improve driving performance (e.g. speed).

The display system 200 includes the pixel array 212 that includes a plurality of light emitting pixels, e.g., the pixels P11 through P43. A pixel is a small element on a display that can change color based on image data supplied to the pixel. Each pixel within the pixel array 212 can be addressed separately to produce various intensities of color. The pixel array 212 extends in a plane and includes rows and columns.

Each row extends horizontally across the pixel array 212. For example, the first row 220 of the pixel array 212 includes pixels P11, P12, and P13. Each column extends vertically down the pixel array 212. For example, the first column 230 of the pixel array 212 includes pixels P11, P21, P31, and P41. Only a few pixels are shown in FIG. 2 for simplicity. In practice, there may be several million pixels in the pixel array 212. Greater numbers of pixels can result in higher image resolution.

The display system 200 includes gate line drivers 210 and column line drivers 208. The gate line drivers supply gate signals to rows of the pixel array 212 via gate lines G1 to G4. The column line drivers 208 supply data signals to columns of the pixel array 212 via column data lines D1 to D4. Each pixel in the pixel array 212 is addressable by a horizontal gate line and a vertical column data line.

The gate lines are addressed sequentially for each frame. A frame is a single image in a sequence of images that are displayed. A scan direction determines the order in which the gate lines are addressed. In the display system 200, the scan direction is from top to bottom of the pixel array 212. For example, the gate line G1 is addressed first, followed by the gate line G2, then G3, etc.

The display system 200 includes a timing controller 206 that receives input from a system-on-a-chip (SoC) 202. The SoC 202 can include a central processing unit (CPU), a graphics processing unit (GPU), and a memory. The SoC 202 can generate image data and send the image data to the timing controller 206. The SoC 202 can also determine the mode of the display system 200. For example, in response to the display system 200 being idle for a certain period of time, the SoC 202 can determine to enter the power save mode. The SoC can trigger the display system 200 to enter the power save mode, for example, by sending a message to the timing controller 206 to adjust control signals for the display.

The timing controller 206 generates control signals. The control signals can include gate driver input signals. Example gate driver input signals can include gate clock (GCLK) signals and gate start pulses (GSP). The gate driver input signals can also include emission (EM) start pulses (ESP) and scan start pulses (SSP). The control signals can also include column data signals. Using the control signals, the timing controller 206 controls the timing of the gate signals through the gate lines G1 to G4. The timing controller 206 also controls the timing of the column data signals through the data lines D1 to D4.

The gate line drivers 210 can include gate drivers, scan drivers, and emission (EM) drivers. Based on the input signals GCLK, GSP, SSP, and ESP, the gate line drivers 210 send drive signals to the pixel rows. For example, based on receiving a GSP, the gate line drivers 210 can send a gate write signal (GW) to the pixel rows through the gate lines G1 to G4. The gate line drivers 210 can use a shift register circuit to generate row-by-row shifting pixel addressing signals during a display frame time.

In some examples, the gate line drivers 210 can include a single shift register circuit for all pixel rows. With a single shift register circuit, once a shifting operation starts, the driver circuit sequentially addresses all pixel rows in the display panel. For an always-on display with a single shift register circuit, all pixel rows are addressed whether the display panel is in a normal operating mode or a power save mode.

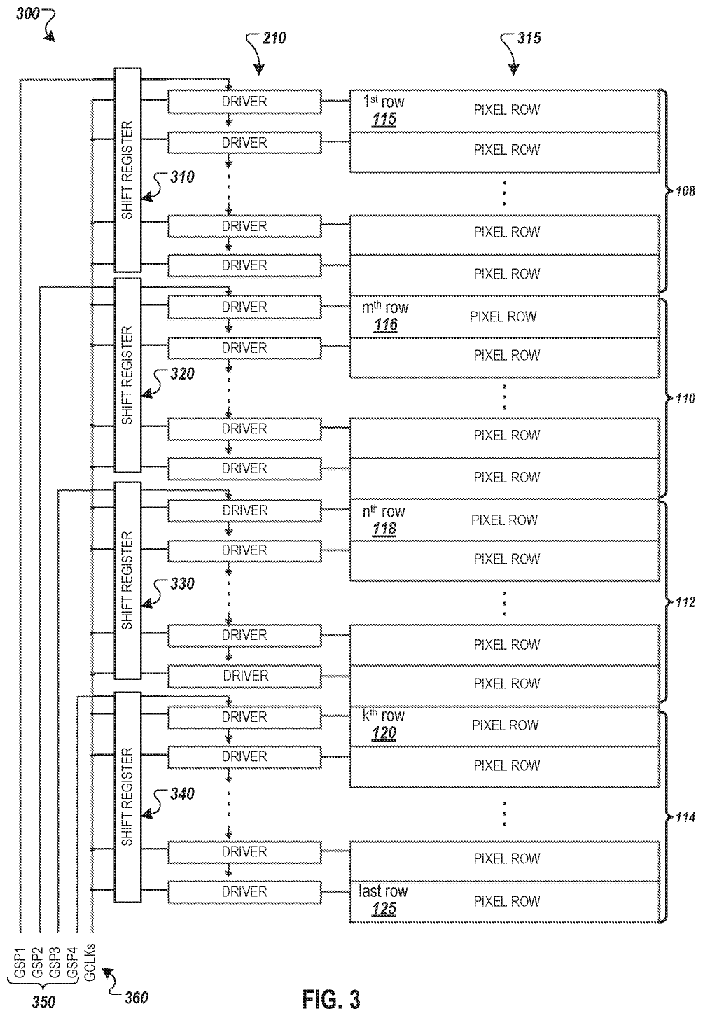

In some examples, the gate line drivers 210 can include more than one independently drivable shift register circuit. Each shift register circuit can address one or more, but not all, of the pixel rows. Each display area of the display panel 102 can be addressed by a different shift register circuit. The timing controller 206 can control the timing of the individual shift register circuits. Operation of the shift register circuits is described in additional detail with reference to FIG. 3.

FIG. 3 is a diagram of an example system 300 for driving pixel rows of a display. The system 300 includes pixel rows 315. The pixel rows 315 include the Pt row 115 and the last row 125. Between the Pt row 115 and the last row 125 are pixels rows 315 that include the m^{th} row 116, the n^{th} row 118, and the k^{th} row 120.

The system 300 includes four shift registers 310, 320, 330, and 340. Each shift register addresses more than one, but not all, of the pixel rows. For example, the shift register 310 addresses pixel rows 315 within the display area 108. The shift register 320 addresses pixel rows 315 within the display area 110. The shift register 330 addresses pixel rows 315 within the display area 112. The shift register 340 addresses pixel rows 315 within the display area 114.

The system 300 includes drivers, e.g., gate line drivers 210. Based on input from the shift registers 310, 320, 330, and 340, the drivers 210 generate line-by-line shifting pixel addressing signals during a display frame time.

In order to independently drive four shift registers, the number of gate start pulses (GSPs) 350 from the timing controller 306 can be the same as the number of shift registers 310, 320, 330, 340. Thus, the system 300 includes four GSPs 350: GSP1, GSP2, GSP3, and GSP4. The four shift registers all share the same clock signals (GCLKs) 360.

In operation, the timing controller 206 sends GSP1 to the shift register 310, GSP2 to the shift register 320, GSP3 to the shift register 330, and GSP4 to the shift register 340. The shift register 310 sequentially addresses the 1^{st} row 115 to the (m−1)^{th} row. The shift register 320 sequentially addresses the m^{th} row 116 to the (n−1)^{th} row. The shift register 330 sequentially addresses the n^{th} row 118 to the (k−1)^{th} row. The shift register 340 sequentially addresses the k^{th} row 120 to the last row 125.

In a power save mode, some, but not all, of the display areas may be showing images. Therefore, the timing controller 206 may determine not to address pixel rows 315 in all display areas. For example, the timing controller 206 can send GSP2 to shift register 320 and GSP4 to shift register 340. The timing controller 206 can determine not to send GSP1 to shift register 310, nor to send GSP3 to shift register 330. In some examples, sending a GSP can include setting a GSP signal to a low value, while not sending a GSP can include maintaining a GSP signal set to a high value.

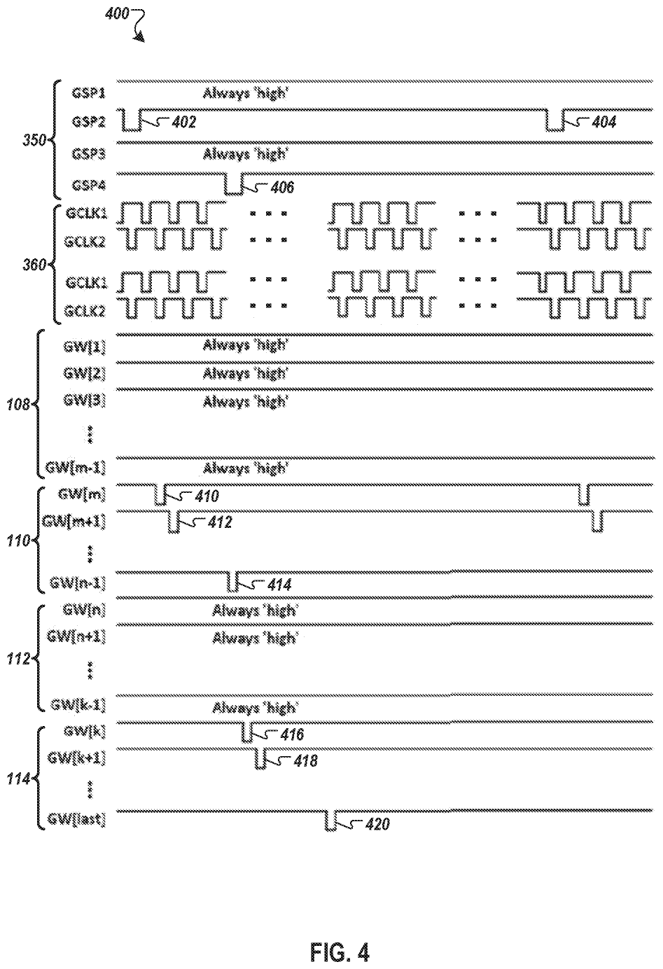

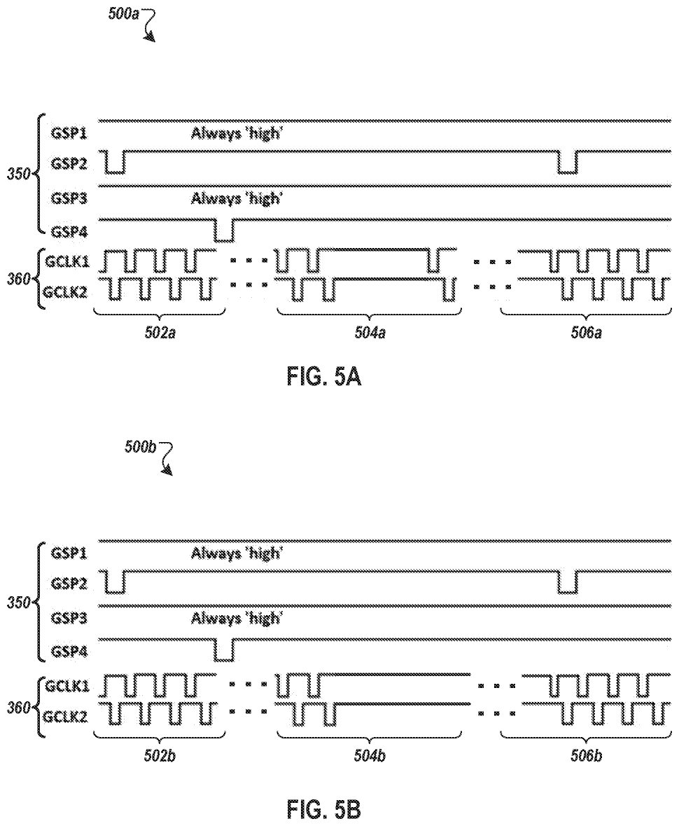

As a result of sending GSP2 and GSP4, while not sending GSP1 and GSP3, the pixel rows 315 in display areas 110 and 114 are addressed, while the pixel rows 315 in display areas 108 and 112 are not addressed. The pixel rows 315 in display areas 108 and 112 remain off. By addressing pixel rows 315 in only some of the display areas, the display system can reduce the amount of power consumed, and extend battery life. Example timing diagrams for partial area display techniques are illustrated in FIGS. 4, 5A, and 5B.

FIG. 4 is an example operating timing diagram 400 for a display in a power save mode. In the power save mode, pixels in two out of four display areas remain unilluminated, while pixels in two out of four display areas may be illuminated.

The timing diagram 400 illustrates GSPs 350, GCLKs 360, and GW signals for display areas 108, 110, 112, 114 over a period of time. The GCLKs 360 are shared between the display areas, and regulate the timing of the driving signals.

The GSPs 350 cause the gate line drivers 210 to send the GW signals to the pixel rows 315. A high GSP value causes a high GW signal. With a high GW signal, the pixel rows are not addressed, e.g., the pixels are powered off. A low GSP value causes the gate line drivers 210 to send a low GW signal to the pixel rows. With a low GW signal, the pixel rows of a display area are addressed in sequence. The sequence can begin with a first row of display area and progress row-by-row to the final row of the display area. For example, the sequence for display area 110 can begin with the m^{th} row 116 and progress row-by-row to the (n−1)^{th} row

In the power save mode, the timing controller 206 maintains GSP1 and GSP3 at a high value (“always high”) such that the pixels of display areas 108 and 112 remain off. The pixel rows of the display area 108 share a same shift register, e.g., the shift register 310. In response to receiving the always high GSP1 signal, the shift register 310 deactivates, and the gate line drivers send the always high GW signal to all pixel rows from the 1^{st} pixel row to the (m−1)^{th} pixel row. The always high GW signal causes the pixel rows within the display area 108 to remain unilluminated, or powered off.

Similar to the display area 108, the pixel rows of the display area 112 share a same shift register, e.g., the shift register 330. In response to receiving the always high GSP3 signal, the shift register 330 deactivates, and the gate line drivers send an always high GW signal to all pixel rows from the n^{th} pixel row to the (k−1)^{th} pixel row. The always high GW signal causes the pixel rows within the display area 112 to remain powered off. Thus, the display areas 108 and 112 remain unilluminated and appear black during the power save mode.

The timing controller 206 can send start pulses by setting GSP2 and GSP4 to low values at designated intervals, causing the pixels of display areas 110 and 114 to illuminate. A time between GSP pulses can be a frame time for the display area. For example, the time between the start of GSP2 pulse 402 and the start of GSP2 pulse 404 is the frame time for display area 110. The time between the start of GSP4 pulse 406 and a next GSP4 pulse is the frame time for display area 114.

The rows of the display area 110 share a same shift register, e.g., the shift register 320. In response to receiving the GSP2 pulse 402, the shift register 320 directs the gate line drivers 210 to send GW pulse 410 to the m^{th} row 116, which is the first row of display area 110. Sending a GW pulse can include, for example, setting the GW signal to a low value for a period of time, and returning the GW pulse to a high value. The shift register 320 directs the gate line drivers 210 to send GW pulse 412 to the row m+1 after the end of the GW pulse 410. The shift register 320 directs the gate line drivers 210 to send the GW pulses sequentially to each row, up to and including sending the GW pulse 414 to row n−1. One or more pixels within the display area 110 can be illuminated, and thus an image can be shown in the display area 110.

The rows of the display area 114 share a same shift register, e.g., the shift register 340. In response to receiving the GSP4 pulse 406, the shift register 340 directs the gate line drivers 210 to send GW pulse 416 to the k^{th} row 120, which is the first row of display area 114. The shift register 340 directs the gate line drivers 210 to send the GW pulse 418 to the row k+1 after the end of the GW pulse 416. The shift register 340 directs the gate line drivers 210 to send the GW pulses sequentially to each row, up to and including sending the GW signal 420 to the last row. One or more pixels within the display area 114 can be illuminated, and thus an image can be displayed in the display area 114.

As the pixels in display areas 108 and 112 are not driven by the gate line drivers in the power save mode, the dynamic power consumption in the gate line driver circuits decreases. Since pixels in the display areas 110 and 114 are driven by the gate line drivers in the power save mode, images can be shown in the display areas 110 and 114.

Though the timing diagram 400 only illustrates the GSPs 350, other start pulses can have similar timing diagrams. For example, the gate line drivers can include additional driver circuits, e.g., scan driver circuits and EM driver circuits. The number of SSPs and ESPs can be the same as the number of shift registers, e.g., the same as the number of independently drivable display areas. For example, the timing sequence illustrated in FIG. 4 can also include SSP1 to SSP4, and ESP1 to ESP4, in addition to GSP1 to GSP4

FIGS. 5A and 5B are example operating timing diagrams 500a and 500b for displays in a power save mode with reduced clock signal frequency, and with zero clock signal frequency, respectively. During the power save mode, the display may show limited information, e.g., date, time, and weather information. Thus, the display may not require refreshing as frequently as during the normal operating mode. For example, images for the time display may only change once per minute, and images for weather information may change even less frequently. To reduce power consumption, the display system can reduce clock frequency to reduce the refresh rate of the pixels that are illuminated during the power save mode. In some examples, the clock signal frequency can be as low as zero.

The timing diagram 500 in FIG. 5A shows the timing sequence for a display in a power save mode with reduced clock signal frequency. The GSPs 350 in FIG. 5A are similar to the GSPs 350 in FIG. 4. The GCLKs 360, including GCLK1 and GCLK2, can each adjust to a lower frequency during a power save mode.

During time 502a, the GCLKs 360 are at a normal operating frequency. During time 502a, the timing controller 206 sends a GSP2 pulse and a GSP4 pulse to address pixels in display areas 110 and 114, respectively. Once the pixels in display areas 110 and 114 are addressed, the GCLKs 360 can slow to a reduced frequency.

During time 504a, the GCLKs 360 slow to a reduced frequency. At a reduced frequency, there is a greater amount of time between clock pulses of the GCLKs 360. The GCLKs 360 can return to a normal operating frequency, for example, after a designated period of time, e.g., a frame time. During time 506a, a new frame begins, and the GCLKs 360 return to a normal operating frequency.

The timing diagram in FIG. 5B shows the timing diagram for a display in a power save mode with zero clock signal frequency. The GSPs 350 in FIG. 5B are similar to the GSPs 350 in FIG. 4 and FIG. 5A. The GCLKs 360 can adjust to a zero frequency during a power save mode.

During time 502b, the GCLKs 360 are at a normal operating frequency. During time 502b, the timing controller 206 sends a GSP2 pulse and a GSP4 pulse to address pixels in display areas 110 and 114, respectively. Once the pixels in display areas 110 and 114 are addressed, the GCLKs 360 can slow to a zero frequency.

During time 504b, the GCLKs 360 reduce to a zero frequency. At a zero frequency, there are no clock pulses. The GCLKs 360 can return to a normal operating frequency, for example, after a designated period of time, e.g., a frame time. During time 506b, a new frame begins, and the GCLKs 360 return to a normal operating frequency.

As the clock frequency of the GCLKs 360 are reduced, the power consumption in the timing controller 206 consumes less power, and battery life can be extended.

FIGS. 6A and 6B illustrate an electronic device 100 with alternating active display areas, and an example operating timing diagram 600 for alternating active display areas.

A pixel that is frequently illuminated may experience burn-in, or image sticking. Burn-in can be caused by changes to properties of an OLED of a pixel when the pixel is illuminated for long periods of time. The OLEDs can gradually become dimmer over time. Burn-in can appear on a display as “image sticking,” where a display may show a faint remnant of an image after a new image appears on the screen. If a first pixel is illuminated more frequently, or for longer durations of time, than a second pixel, the first pixel may experience more burn-in than the second pixel, potentially causing distortions in displayed images.

To reduce burn-in, pixels that are illuminated during the power save mode can be alternated over time. For example, in FIG. 1, the display panel 102 shows the time indication 104 in the display area 110, while the display area 108 is unilluminated. In FIG. 6A, the display panel 102 shows the time indication 104 in the display area 108, while the display area 110 is unilluminated. By alternating the display areas that are active during the power save mode, the display system can reduce effects of burn-in.

FIG. 6B illustrates an example operating timing diagram for alternating active display areas. The GSPs in FIG. 6B are similar to the GSPs in FIG. 4. However, instead of maintaining GSP2 always high, the timing controller 206 maintains the GSP1 always high. Thus, the pixels in display area 110 remain unilluminated, while the pixels in display area 108 are addressed by the gate line drivers. By alternating the active start pulses between GSP2 and GSP1, the location of the images on the screen can be changed, while the display system can benefit from the power reduction of the power save mode.

Embodiments of the subject matter and the functional operations described in this specification can be implemented in any suitable electronic device such as a personal computer, a mobile telephone, a smart phone, a smart watch, a smart TV, a mobile audio or video player, a game console, or a combination of one or more of these devices.

The electronic device may include various components such as a memory, a processor, a display, and input/output units. The input/output units may include, for example, a transceiver which can communicate with the one or more networks to send and receive data. The display may be any suitable display including, for example, a cathode ray tube (CRT), liquid crystal display (LCD), or light emitting diode (LED) display, for displaying images.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Embodiments may be implemented as one or more computer program products, e.g., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both.

Elements of a computer may include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer may not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of driving a display comprising an array of light-emitting pixels arranged in a plurality of rows, the array comprising two or more independently drivable areas, each area comprising two or more adjacent rows, the method comprising:
during an image frame, while operating in a first mode of operation, activating a first shift register circuit addressing only rows of pixels in a first area of the independently drivable areas to illuminate one or more pixels in the first area; and
during the image frame, while operating in the first mode of operation, deactivating a second shift register circuit addressing only rows of pixels in a second area of the independently drivable areas to maintain every pixel in the second area unilluminated during the image frame.

2. The method of claim 1, further comprising:
during a second image frame, while operating in a first mode of operation, activating the second shift register circuit addressing only rows of pixels in the second area of the independently drivable areas to illuminate one or more pixels in the second area; and
during the second image frame, while operating in the first mode of operation, deactivating the first shift register circuit addressing only rows of pixels in the first area of the independently drivable areas to maintain every pixel in the first area unilluminated during the image frame.

3. The method of claim 1, further comprising adjusting an input clock signal to a reduced frequency while operating in the first mode of operation.

4. The method of claim 1, further comprising adjusting an input clock signal to a zero frequency while operating in the first mode of operation.

5. The method of claim 1, wherein addressing only rows of pixels in the first area comprises sending one or more of a gate write signal, a scan signal, and an emission signal to the rows of pixels in the first area.

6. The method of claim 1, wherein the display is an always-on display and the first mode of operation is a power save mode.

7. The method of claim 1, wherein the display is an always-on display and a second mode of operation is a mode in which all of the independently drivable areas are activated.

8. The method of claim 1, wherein activating the first shift register circuit comprises sending a first start pulse to the first shift register circuit.

9. The method of claim 8, wherein the first start pulse can be one or more of a gate start pulse, a scan start pulse, and an emission start pulse.

10. A system comprising:
a display comprising an array of light-emitting pixels arranged in a plurality of rows, the array comprising two or more independently drivable areas, each area comprising two or more adjacent rows;
a controller module in electrical communication with the rows of pixels, the controller module being programmed to:
during an image frame, while operating in a first mode of operation, activate a first shift register circuit addressing only rows of pixels in a first area of the independently drivable areas to illuminate one or more pixels in the first area; and
during the image frame, while operating in the first mode of operation, deactivate a second shift register circuit addressing only rows of pixels in a second area of the independently drivable areas to maintain every pixel in the second area unilluminated during the image frame.

11. The system of claim 10, the controller module further being programmed to:
during a second image frame, while operating in a first mode of operation, activate the second shift register circuit addressing only rows of pixels in the second area of the independently drivable areas to illuminate one or more pixels in the second area; and
during the second image frame, while operating in the first mode of operation, deactivate the first shift register circuit addressing only rows of pixels in the first area of the independently drivable areas to maintain every pixel in the first area unilluminated during the image frame.

12. The system of claim 10, the controller module being programmed to adjust an input clock signal to a reduced frequency while operating in the first mode of operation.

13. The system of claim 10, the controller module being programmed to adjust an input clock signal to a zero frequency while operating in the first mode of operation.

14. The system of claim 10, wherein addressing only rows of pixels in the first area comprises sending one or more of a gate write signal, a scan signal, and an emission signal to the rows of pixels in the first area.

15. The system of claim 10, wherein the display is an always-on display and the first mode of operation is a power save mode.

16. The system of claim 10, wherein the display is an always-on display and a second mode of operation is a mode in which all of the independently drivable areas are activated.

17. The system of claim 10, wherein activating the first shift register circuit comprises sending a first start pulse to the first shift register circuit.

18. The system of claim 17, wherein the first start pulse can be one or more of a gate start pulse, a scan start pulse, and an emission start pulse.

19. A non-transitory computer-readable medium containing instructions which when executed on a data processing apparatus in communication with a display drives the display, the display comprising an array of light-emitting pixels arranged in a plurality of rows, the array comprising two or more independently drivable areas, each area comprising two or more adjacent rows, a method for driving the display when executed comprising:
during an image frame, while operating in a first mode of operation, activating a first shift register circuit addressing only rows of pixels in a first area of the independently drivable areas to illuminate one or more pixels in the first area; and
during the image frame, while operating in the first mode of operation, deactivating a second shift register circuit addressing only rows of pixels in a second area of the independently drivable areas to maintain every pixel in the second area unilluminated during the image frame.

20. The medium of claim 19, the method for driving the display when executed further comprising:
during a second image frame, while operating in a first mode of operation, activating the second shift register circuit addressing only rows of pixels in the second area of the independently drivable areas to illuminate one or more pixels in the second area; and
during the second image frame, while operating in the first mode of operation, deactivating the first shift register circuit addressing only rows of pixels in the first area of the independently drivable areas to maintain every pixel in the first area unilluminated during the image frame.
